(19) United States
(12) Patent Application Publication
(10) Pub. No.: US 2020/0039515 A1
(43) Pub. Date: Feb. 6, 2020

(54) PRECEDING-VEHICLE DETERMINATION APPARATUS AND VEHICLE CONTROL SYSTEM

(71) Applicant: Hino Motors, Ltd., Hino-shi, Tokyo (JP)

(72) Inventors: Yasumitsu SASAKI, Hino-shi (JP); Hiroyuki ISHIZAKA, Hino-shi (JP)

(73) Assignee: Hino Motors, Ltd., Hino-shi, Tokyo (JP)

(21) Appl. No.: 16/496,138

(22) PCT Filed: Jan. 26, 2018
(86) PCT No.: PCT/JP2018/002561

§ 371 Date: Sep. 20, 2019

(30) Foreign Application Priority Data
Mar. 23, 2017 (JP) 2017-058012

(51) Int. Cl. B60W 30/16; B60W 10/06

(52) U.S. Cl. CPC B60W 30/162; B60W 10/06; B60W 2550/146; B60W 2710/081; B60W 2540/18; B60W 2750/308; B60W 2400/00; B60W 2550/308

(57) ABSTRACT

A preceding-vehicle determination apparatus including a curvature-radius estimation unit that estimates a curvature radius R of a road, on which a host vehicle is traveling, based on a steering angle, when the vehicle speed is equal to or lower than a determination threshold value; a coordinate conversion unit that converts, based on the curvature radius R, a position of the preceding vehicle in a first coordinate system in which a curve corresponding to the curvature radius R is used as a reference to a position in a second coordinate system in which a straight line along a straight traveling direction of the host vehicle is used as a reference; and a host-vehicle-lane probability calculation unit that calculates a probability that the preceding vehicle is present on a host-vehicle lane, based on the position of the preceding vehicle in the second coordinate system.

### TECHNICAL FIELD

An aspect of the present invention relates to a preceding-vehicle determination apparatus and a vehicle control system.

### BACKGROUND ART

In the related art, an in-vehicle radar apparatus that is applied to an adaptive cruise control (ACC) system determines a curvature radius of a road, on which a host vehicle is traveling, from a host-vehicle speed detected by a vehicle speed sensor and a yaw rate detected by a yaw rate sensor and determines whether or not a preceding vehicle is present ahead of the host vehicle (for example, see Patent Literature 1).

### CITATION LIST

### Patent Literature

Patent Literature 1: Japanese Unexamined Patent Publication No. 2007-253714

### SUMMARY OF INVENTION

### Technical Problem

However, there is a concern that, when a host vehicle travels at a low speed, vibration of the vehicle increases, and thereby a value acquired by a yaw rate sensor fluctuates. Consequently, there is a concern that a curvature radius is also likely to fluctuate, thus, it is not possible to appropriately determine a position of a preceding vehicle on a curved road, and it is not possible to determine whether or not the preceding vehicle is present on a host-vehicle lane on which the host vehicle travels.

According to an aspect of the invention, an object thereof is to provide a preceding-vehicle determination apparatus and a vehicle control system that is capable of limiting an influence of a measurement error of a yaw rate sensor due to vibration of a vehicle and determining a probability that a preceding vehicle is present on a host-vehicle lane.

### Solution to Problem

A preceding-vehicle determination apparatus according to an aspect of the invention includes: a vehicle speed sensor that detects a speed of a host vehicle; a preceding-vehicle detection sensor that detects a position of a preceding vehicle ahead of the host vehicle; a steering angle sensor that detects a steering angle of the host vehicle; a low speed determination unit that determines whether or not the vehicle speed of the host vehicle detected by the vehicle speed sensor is equal to or lower than a determination threshold value; a curvature-radius estimation unit that estimates a curvature radius R of a road, on which the host vehicle is traveling, based on the steering angle, when the vehicle speed is equal to or lower than the determination threshold value; a coordinate conversion unit that converts, based on the curvature radius R, the position of the preceding vehicle in a first coordinate system in which a curve corresponding to the curvature radius R is used as a reference to a position in a second coordinate system in which a straight line along a straight traveling direction of the host vehicle is used as a reference; and a host-vehicle-lane probability calculation unit that calculates a probability that the preceding vehicle is present on a host-vehicle lane, based on the position of the preceding vehicle in the second coordinate system.

The preceding-vehicle determination apparatus includes the low speed determination unit and estimates the curvature radius R of the road, on which the host vehicle is traveling, based on the steering angle, when the vehicle speed of the host vehicle is equal to or lower than the determination threshold value. Hence, it is possible to estimate the curvature radius R without using a yaw rate. When the vehicle speed of the host vehicle is equal to or lower than the determination threshold value, it is possible to limit an influence of an error, even in a case where the curvature radius R of the road, on which the host vehicle is traveling, is estimated based on the steering angle. The position of the preceding vehicle is converted to the position in the second coordinate system in which the straight line along the straight traveling direction of the host vehicle is used as a reference, and thus it is possible to significantly reduce a computation load more than in the case of converting the entire coordinate system. Consequently, it is possible to determine the position of the preceding vehicle with respect to the host vehicle with high accuracy and determine the probability that the preceding vehicle is present on the host-vehicle lane.

The preceding-vehicle detection sensor may detect a first distance L_{Y} from the host vehicle to the preceding vehicle in the straight traveling direction of the host vehicle and a second distance L_{X} from the host vehicle to the preceding vehicle in a vehicle width direction orthogonal to the straight traveling direction. The coordinate conversion unit may calculate a distance m between the preceding vehicle and the curve corresponding to the curvature radius R, the curve passing through a center of the host vehicle in the vehicle width direction. The host-vehicle-lane probability calculation unit may calculate a probability that the preceding vehicle is present on the host-vehicle lane, based on the distance m. Consequently, it is possible to reduce the computation load and calculate the probability that the preceding vehicle is present on the host-vehicle lane, based on the second distance Lₓ from the host vehicle to the preceding vehicle in the vehicle width direction.

The coordinate conversion unit may calculate the distance m by using Expression (1) below.

[Math. 1]

m=[L_{Y}²+(|R|−L_{X}|)²]^{0.5}−|R| (1)

Consequently, it is possible to reduce the computation load and calculate the probability that the preceding vehicle is present on the host-vehicle lane.

A vehicle control system according to another aspect of the invention includes the preceding-vehicle determination apparatus. The vehicle control system further includes a preceding-vehicle presence/absence determination unit that determines whether or not the preceding vehicle is present on the host-vehicle lane, depending on a probability that the preceding vehicle is present on the host-vehicle lane, and a vehicle control unit that controls an inter-vehicular distance between the preceding vehicle and the host vehicle, when the preceding vehicle is present on the host-vehicle lane.

The host vehicle may include an engine retarder. The vehicle control unit may control the engine retarder to decelerate the host vehicle and control the inter-vehicular distance. Consequently, it is possible to limit wear of a brake shoe.

### Advantageous Effects of Invention

According to an aspect of the invention, it is possible to provide a preceding-vehicle determination apparatus and a vehicle control system that is capable of limiting an influence of a measurement error of a yaw rate sensor due to vibration of a vehicle and determining whether or not a preceding vehicle is present with high accuracy.

### BRIEF DESCRIPTION OF DRAWINGS

FIG. 1 is a side view illustrating a large-sized vehicle on which a vehicle control system of an embodiment is mounted and a preceding vehicle ahead of the large-sized vehicle.

FIG. 2 is a plan view illustrating the preceding vehicle ahead of a host vehicle.

FIG. 3 is a block configuration diagram illustrating the vehicle control system.

FIG. 4 is a block configuration diagram illustrating a cruise ECU in FIG. 2.

FIG. 5 is a schematic diagram illustrating a steering angle of the host vehicle that is traveling on a curved road and a curvature radius of the curved road.

FIG. 6 is a schematic diagram illustrating a position of the preceding vehicle on the curved road on which the host vehicle is traveling.

FIG. 7(a) is a schematic diagram illustrating the position of the preceding vehicle on the curved road. FIG. 7(b) is a schematic diagram illustrating a position of the preceding vehicle after conversion of the position of the preceding vehicle in a coordinate system in which a straight line extending in a straight traveling direction Y is used as a reference.

FIGS. 8(a) and 8(b) are diagrams illustrating a map on which a host-vehicle-lane probability is shown.

FIG. 9 is a flowchart illustrating a process procedure in a vehicle control system.

### DESCRIPTION OF EMBODIMENTS

Hereinafter, a preferred embodiment of the invention will be described in detail with reference to the drawings. Incidentally, in the drawings, the same reference signs are assigned to the same parts or equivalent parts, and the repeated description thereof is omitted.

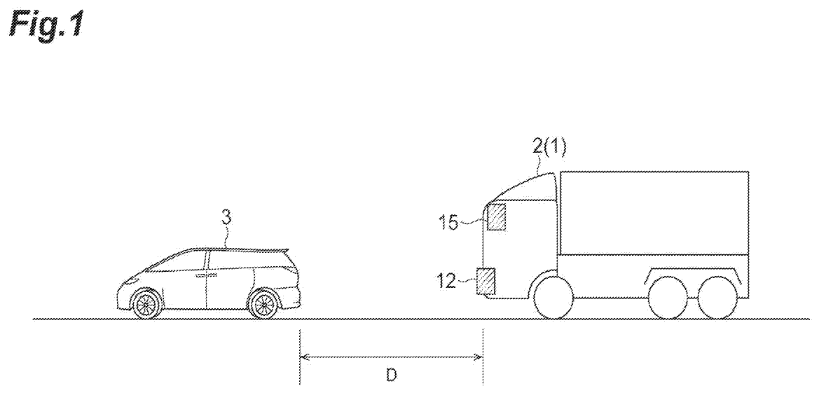

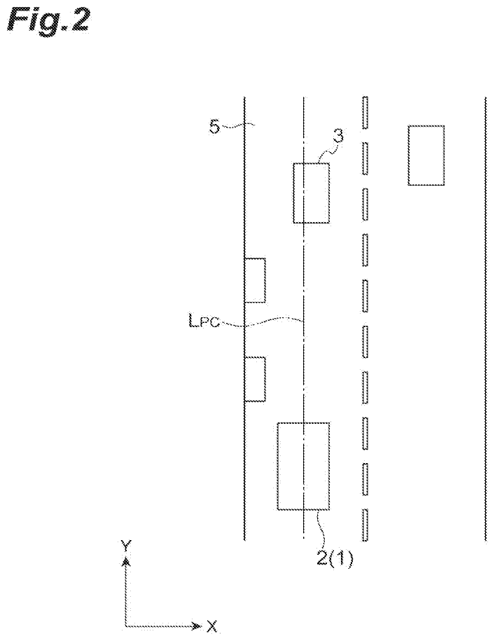

As illustrated in FIGS. 1 and 2, a vehicle control system (preceding-vehicle determination apparatus) 1 is mounted on a host vehicle 2 and has a function of assisting drive of the host vehicle 2. An example of the function executed by the vehicle control system 1 includes adaptive cruise control (ACC). The ACC allows execution of a constant speed traveling function of maintaining a vehicle speed of the host vehicle 2 (hereinafter, referred to as a “host-vehicle speed”) and an inter-vehicular distance control function of controlling an inter-vehicular distance D between the host vehicle 2 and a preceding vehicle 3. The host vehicle 2 is a large-sized vehicle such as a truck, for example. The host vehicle 2 may be a bus or any vehicle such as a large-sized vehicle other than the bus, a medium-sized vehicle, an ordinary passenger vehicle, a small-sized vehicle, or a light vehicle.

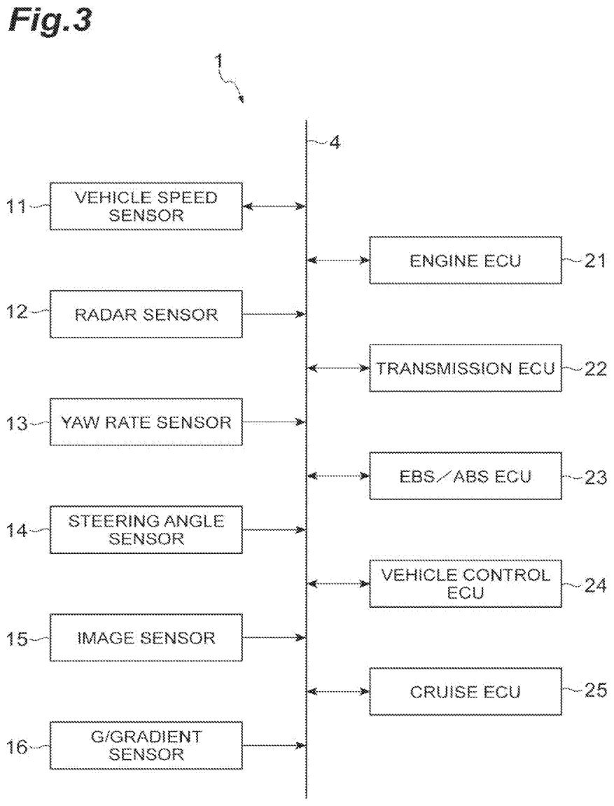

The host vehicle 2 has an in-vehicle network. As illustrated in FIG. 3, through the in-vehicle network, a plurality of electronic control units (ECU) 21 to 25 that control various functions of the host vehicle 2 are connected to each other via a communication line 4. The in-vehicle network enables data communication between the plurality of ECUs 21 to 25.

The vehicle control system 1 includes various sensors. Examples of the various sensors include a vehicle speed sensor 11, a radar sensor 12, a yaw rate sensor 13, a steering angle sensor 14, an image sensor 15, a G/gradient sensor 16, and the like. The various sensors are connected to the plurality of ECUs 21 to 25 via the communication line 4. Data acquired by the various sensors is transmitted to the plurality of ECUs 21 to 25.

The vehicle speed sensor 11 detects the host-vehicle speed. The vehicle speed sensor 11 is attached to a wheel 6 of the host vehicle 2 and detects a rotation angular velocity of the wheel.

The radar sensor 12 can use a millimeter-wave radar or a laser radar, for example. The radar sensor 12 transmits a radar wave such as a millimeter wave. The radar sensor 12 computes a distance to an object based on a time taken to receive a reflected wave obtained when the transmitted radar wave is reflected on the object. The radar sensor 12 detects an orientation of the object with respect to the host vehicle from a receiving direction of the reflected wave. Consequently, it is possible to calculate a position (x, y) of the preceding vehicle 3 ahead of the host vehicle 2.

The yaw rate sensor 13 is attached to be parallel to a vertical axis of the host vehicle 2 and detects a rotation angular velocity (yaw rate) around the vertical axis of the host vehicle 2. The steering angle sensor 14 is attached to a steering wheel, detects a steering wheel operation by a driver, and detects a steering angle (rotation angle of the steering wheel) θ_{S}. The image sensor 15 is attached to an upper front portion of the host vehicle 2 and acquires a front image of the host vehicle 2. The G/gradient sensor 16 is horizontally attached to the vicinity of a position of the center of gravity of the host vehicle 2 and detects acceleration in a front-rear direction and acceleration in a left-right direction of the center of gravity of the host vehicle 2.

The vehicle control system 1 includes the plurality of ECUs 21 to 25. Examples of the plurality of ECUs 21 to 25 include the engine ECU 21, the transmission ECU 22, the electric brake system (EBS)/antilock brake system (ABS) ECU 23, the vehicle control ECU (vehicle control unit) 24, the cruise ECU 25, and the like. The ECU is configured of a computer including a central processing unit (CPU), a read only memory (ROM), and a random access memory (RAM).

The engine ECU 21 is a control unit, which controls an engine of the host vehicle 2, and controls an ignition timing of the engine, an amount of fuel injection, valve opening and closing, or the like, for example. The engine ECU 21 detects various items of data (for example, engine RPM, engine water temperature, or the like) for detecting a state of the engine and transmits data indicating a state of the engine.

The transmission ECU 22 is a control unit, which controls an automated manual transmission (AMT) of the host vehicle 2, and controls switching or the like of a gear of the automated manual transmission. The transmission ECU 22 detects a state of the automated manual transmission and transmits data indicating a state of the automated manual transmission.

The EBS/ABS ECU 23 is a control unit, which controls a brake, and controls an operation timing of the brake, a degree of a braking force, or the like. The EBS/ABS ECU 23 detects an operating state of the brake and transmits data indicating an operating state of the brake.

The vehicle control ECU 24 is a control unit, which controls the entire vehicle, and controls the plurality of ECUs to perform control or the like related to a drive assist. The vehicle control ECU 24 receives data related to a state of the vehicle from the plurality of ECUs and transmits data related to a command signal to the plurality of ECUs.

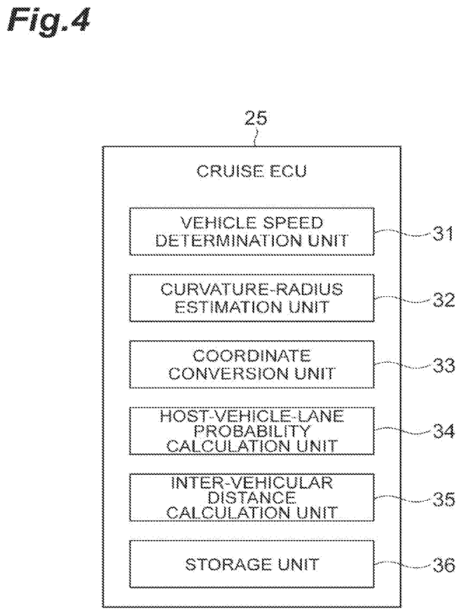

The cruise ECU 25 is a control unit, which controls the ACC, and, for example, controls the plurality of ECUs 21 to 25 to perform the constant speed traveling control and the inter-vehicular distance control. As illustrated in FIG. 4, the cruise ECU 25 includes a vehicle speed determination unit (low speed determination unit) 31, a curvature-radius estimation unit 32, a coordinate conversion unit 33, a host-vehicle-lane probability calculation unit (preceding-vehicle presence/absence determination unit) 34, an inter-vehicular distance calculation unit 35, and a storage unit 36.

The vehicle speed determination unit 31 determines whether or not the host-vehicle speed of the host vehicle 2 detected by the vehicle speed sensor 11 is equal to or lower than a determination threshold value. The determination threshold value is 40 km/h, for example.

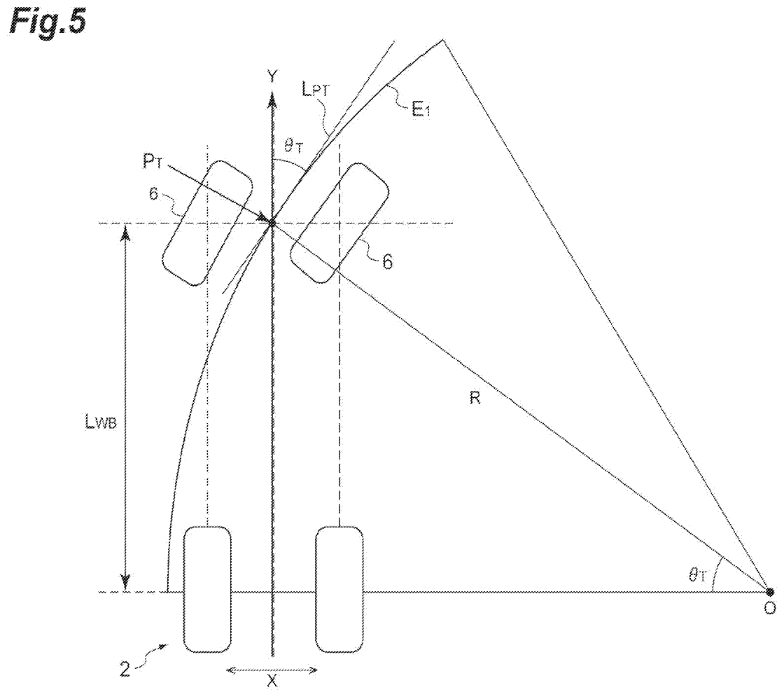

When the host vehicle 2 travels on a curved road, and the host-vehicle speed is equal to or lower than the determination threshold value, the curvature-radius estimation unit 32 estimates a curvature radius R of a road, on which the host vehicle 2 is traveling, based on a tire angle θ_{T} to be described below, as illustrated in FIG. 5. The detailed description thereof is as follows. When the host vehicle 2 travels on the curved road, and the host-vehicle speed is higher than the determination threshold value, the curvature-radius estimation unit 32 estimates the curvature radius R of the curved road, on which the host vehicle 2 is traveling, based on the yaw rate detected by the yaw rate sensor 13 and the host-vehicle speed detected by the vehicle speed sensor 11.

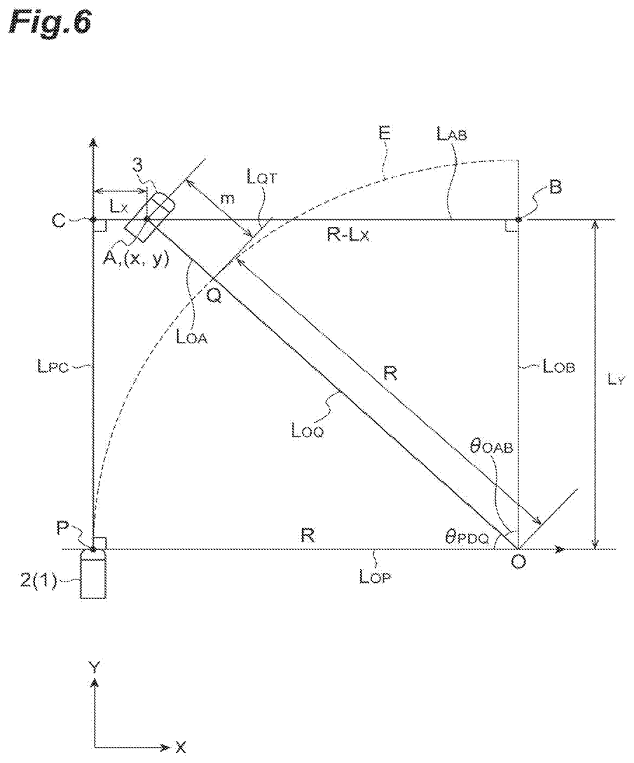

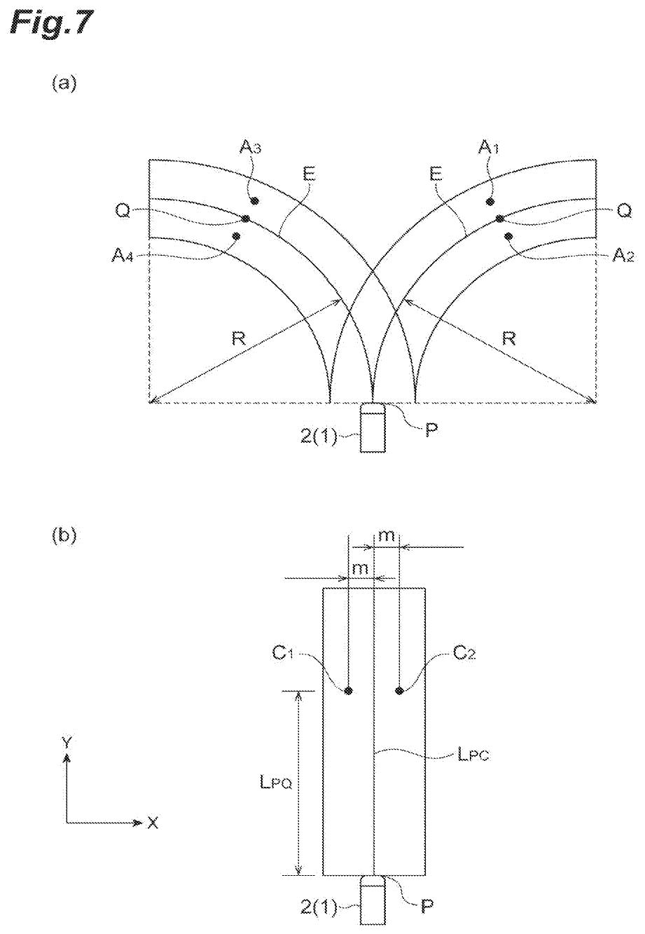

As illustrated in FIG. 6, the coordinate conversion unit 33 converts a position A of the preceding vehicle 3 in a first coordinate system in which a curve (estimated centerline E) corresponding to the curved road is used as a reference to a position in a second coordinate system in which a straight line L_{PC} along a straight traveling direction Y of the host vehicle 2 is used as a reference. For example, the coordinate conversion unit 33 converts positions A₁, A₂, A₃, and A₄ of the preceding vehicle 3 in the first coordinate system illustrated in FIG. 7(a) to positions C₁ and C₂ in the second coordinate system illustrated in FIG. 7(b).

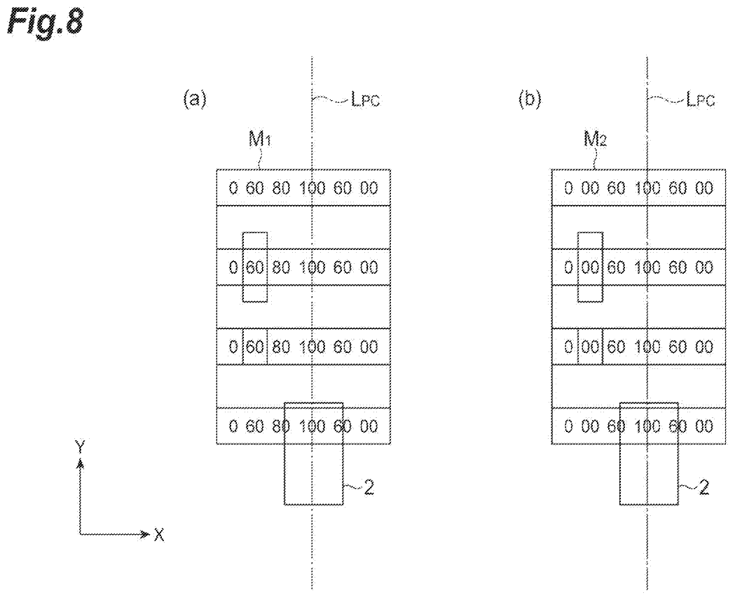

The host-vehicle-lane probability calculation unit 34 calculates a probability (host-vehicle-lane probability) that the preceding vehicle (other vehicle) 3 ahead of the host vehicle 2 is present on the host-vehicle lane. The host-vehicle-lane probability calculation unit collates the position A of the preceding vehicle 3 with host-vehicle-lane probability calculating maps M₁ and M₂ (refer to FIG. 8) so as to calculate a probability that the preceding vehicle 3 is present on the host-vehicle lane 5. The host-vehicle-lane probability calculation unit 34 calculates the probability that the preceding vehicle 3 is present on the host-vehicle lane 5, based on a distance m from the host vehicle 2 to the preceding vehicle 3 in a vehicle width direction X. orthogonal to the straight traveling direction Y of the host vehicle 2.

For example, on the host-vehicle-lane probability calculating maps M₁ and M₂ illustrated in FIG. 8, a numerical value indicating the host-vehicle-lane probability is set based on the distance m (refer to FIG. 6) from the host vehicle 2 to the preceding vehicle 3 in the vehicle width direction X. For example, when the preceding vehicle 3 is present in front of the host vehicle 2, the host-vehicle-lane probability is set to 100 [%]. As the preceding vehicle 3 is separated from the host vehicle 2 in the vehicle width direction X, the host-vehicle-lane probability is reduced to 80 [%], 60 [%], or 0 [%]. Incidentally, the host-vehicle-lane probability may change depending on whether a target object such as the preceding vehicle 3 is present on the right side of the host vehicle 2 or the target object is present on the left side of the host vehicle 2.

The host-vehicle-lane probability calculation unit 34 may change the host-vehicle-lane probability depending on whether or not the host vehicle 2 travels on a general road. The host-vehicle-lane probability calculation unit 34 may change the host-vehicle-lane probability depending on whether or not the host vehicle travels on a limited highway (for example, expressway). For example, the host-vehicle-lane probability calculating map M₁ illustrated in FIG. 8(a) is applied, when the host vehicle 2 travels on the expressway. The host-vehicle-lane probability calculating map M₂ illustrated in FIG. 8(b) is applied, when the host vehicle 2 travels on the general way. For example, on the general road, there is a concern that a bicycle, a pedestrian, or the like will be present on the left (sidewalk side) of a host-vehicle position, and there is a low possibility that a vehicle travels on the left thereof. Hence, a low host-vehicle-lane probability is set (for example, 0 [%]). On the expressway, there is no concern that a bicycle, a pedestrian, or the like will be present on the left of the host-vehicle position, and there is a possibility that a vehicle travels on the left thereof. Hence, a relatively high host-vehicle-lane probability is set (for example, 60 [%]).

The inter-vehicular distance calculation unit 35 calculates the inter-vehicular distance D between the host vehicle 2 and the preceding vehicle 3. The inter-vehicular distance calculation unit 35 calculates the inter-vehicular distance D (refer to FIG. 1) between the host vehicle 2 and the preceding vehicle 3, based on the position of the preceding vehicle 3 acquired by the radar sensor 12. Calculation of the inter-vehicular distance D when the host vehicle 2 is traveling on the curved road will be described below.

In the storage unit 36, the host-vehicle-lane probability calculating maps M₁ and M₂ are stored, for example. In the storage unit 36, data to be used for estimating the curvature radius R is stored. An example of the data to be used for estimating the curvature radius R includes data related to a wheel base L_{WB} (refer to FIG. 5) of the host vehicle 2.

The cruise ECU 25 transmits command signals to the ECUs 21 to 24 so as to control the host vehicle 2 that needs to maintain the inter-vehicular distance D between the preceding vehicle 3 and the host vehicle 2. The cruise ECU 25 transmits the command signals to the ECUs 21 to 24 so as to control the host-vehicle speed at a constant speed.

The cruise ECU 25 transmits a command signal to the engine ECU 21 so as to control an engine output. The cruise ECU 25 transmits a command signal to the transmission ECU 22 so as to control a transmission. The cruise ECU 25 controls the EBS/ABS ECU 23 so as to control the brake.

The host vehicle 2 includes an engine retarder. The engine retarder opens an exhaust valve between an end of an intake stroke and a start of a compression stroke of the engine and allows high-pressure exhaust in an exhaust pipe to flow back to a cylinder. Consequently, a compression pressure in the cylinder increases such that an effect of an exhaust brake increases. The exhaust brake increases exhaust resistance of the engine, thereby increasing an effect of an engine brake. The cruise ECU 25 transmits a command signal to the vehicle control ECU 24. The vehicle control ECU 24 operates the engine retarder so as to decelerate the host vehicle 2 based on the command signal. Consequently, the brake of the host vehicle 2 is less frequently used, and wear of a brake shoe is limited.

Next, a method of calculating the curvature radius R by using Ackermann's formula will be described with reference to FIG. 5. A midpoint P_{T} illustrated in FIG. 5 is a tread midpoint that is a center point between right and left front wheels (wheels 6). The curvature radius R is a distance from a center point O of a circle E₁ including an arc on which the host vehicle 2 turns to the midpoint P_{T}. The tire angle θ_{T} is an angle formed between a straight line along the straight traveling direction Y of the host vehicle 2 at the midpoint P_{T} and a tangential line L_{PT} of the circle E₁. The wheel base L_{WB} of the host vehicle 2 is a distance between a front axle and a rear axle. In this case, the curvature radius R can be expressed by Expression (2) below.

$$\begin{matrix}[ Math . 2 ] & \\ R = \frac{{L}_{WB}}{sin {θ}_{T}} & ( 2 )\end{matrix}$$

In this case, when “θ_{S}” represents a steering angle (wheel-steering angle), and “K” represents a damping coefficient of steering, the tire angle θ_{T} can be expressed by Expression (3) below. Incidentally, the damping coefficient K of steering is a vehicle specific value and can be measured. For example, the damping coefficient K of steering is 1/20.

[Math. 3]

θ_{T}=Kθ_{S} (3)

Expression (3) is substituted in Expression (2) such that the tire angle θ_{T} can be expressed by Expression (4) below.

$$\begin{matrix}[ Math . 4 ] & \\ R = \frac{{L}_{WB}}{sin ( K {θ}_{s} )} & ( 4 )\end{matrix}$$

Consequently, it is possible to calculate the curvature radius (turning radius of the circle E₁) R of the arc on which the host vehicle 2 travels, by using the wheel base L_{WB} and the steering angle θ_{S} of the host vehicle 2.

Next, with reference to FIG. 6, a computation expression for converting the position of the preceding vehicle 3 that travels on the curved road having the curvature radius R to a position on a map (coordinate system) with the straight traveling direction Y as a reference will be described. First, the case of calculating the distance m (in a horizontal direction) from the estimated centerline E of the host vehicle 2 to the preceding vehicle 3 is described. The distance m means a distance between the estimated centerline E and the preceding vehicle 3 in a direction orthogonal to an estimated traveling direction of the preceding vehicle 3. For example, the distance m may be a distance between the estimated centerline E and the center of the preceding vehicle 3 in the vehicle width direction. The estimated traveling direction is a direction along a curve E or a direction along a straight line L_{QT}, for example.

The position (x, y) of the preceding vehicle 3 detected by the radar sensor 12 is located at L_{Y} (=y) representing a distance (first distance) of the host vehicle 2 in the straight traveling direction Y and L_{X} (=x) representing a distance (second distance) in the vehicle width direction X orthogonal to the straight traveling direction Y. Incidentally, a sign of L_{X} when the preceding vehicle 3 is present on the right from the center of the host vehicle 2 in the vehicle width direction X is set to “plus”. A sign of L_{X} when the preceding vehicle 3 is present on the left from the center of the host vehicle 2 in the vehicle width direction X is set to “minus”. R represents an estimated curvature radius of the curved road, on which the host vehicle 2 is traveling. Incidentally, a sign of the curvature radius R when the road has a right-hand curve is set to “plus”. A sign of the curvature radius R when the road has a left-hand curve is set to “minus”.

As illustrated in FIG. 6, the position of the preceding vehicle 3 is set as a point A, and a center point of a virtual circle of the curved road having the curvature radius R is set as the point O. An intersection point of a straight line L_{OB} with a straight line L_{AB} is set as a point B. The straight line L_{OB} is parallel to the straight traveling direction Y, the straight line L_{OB} passing through the center point O. The straight line L_{AB} is parallel to the vehicle width direction X, the straight line L_{AB} passing through the position A of the preceding vehicle 3. Lengths of sides (OA, OB, and AB) of a right triangle with the points O, A, and B as vertexes can be expressed by Expressions (5) to (7) below.

[Math. 5]

OA=|R|+m (5)

OB=L_{Y} (6)

AB=|R|−|L_{X}| (7)

The lengths of the sides (OA, OB, and AB) of the right triangle satisfy Expression (8) below.

[Math. 6]

OA=(OB²+AB²)^{0.5} (8)

When Expressions (5) to (7) are substituted in Expression (8), Expression (9) below is obtained.

[Math. 7]

|R|+m=[L_{Y}²+(|R|−|L_{X}|)²]^{0.5} (9)

Hence, it is possible to calculate m by using Expression (1) below.

[Math. 8]

m=[L_{Y}²+(|R|−|L_{X}|)²]^{0.5}−|R| (1)

Here, O represents the center point of the virtual circle having the curvature radius R, and P represents a position of the host vehicle 2. Q represents an intersection point of a straight line L_{OA} connecting the center point O and the point A which is the position of the preceding vehicle 3 with the estimated centerline E which is an arc of the virtual circle. θ_{POQ} represents an intersection angle between a straight line L_{OP} and a straight line L_{OQ},and θ_{OAB} represents an intersection angle between the straight line L_{OB} and the straight line L_{AB}. The straight line L_{OP} is parallel to the straight line L_{AB}.

In this case, the intersection angle θ_{POQ} is equal to θ_{OAB}, and thus Expression (10) below is satisfied.

$$\begin{matrix}[ Math . 9 ] & \\ {θ}_{POQ} = {θ}_{AOB} = arccos ( \frac{AB}{OA} ) & ( 10 )\end{matrix}$$

A length of an arc PQ of the virtual circle having the curvature radius R satisfies Expression (11) below.

$$\begin{matrix} [ Math . 10 ] & \\ arc PQ = \vert R \vert \cdot arccos ( \frac{AB}{OA} ) = \vert R \vert \cdot arccos ( \frac{\vert R \vert - \vert {L}_{X} \vert}{{[ {L}_{Y}^{2} + {( \vert R \vert - \vert {L}_{X} \vert )}^{2} ]}^{0.5}} ) & ( 11 )\end{matrix}$$

Expressions (1) and (11) above are applied to a map, and thereby it is possible to convert the position A of the preceding vehicle 3 to a position in the second coordinate system in which the straight line L_{PC} extending in the straight traveling direction. Y is used as a reference, as illustrated in FIG. 7(b). The inter-vehicular distance calculation unit 35 of the cruise ECU 25 sets the arc PQ (=L_{PQ}) calculated from Expression (11) as the inter-vehicular distance D (refer to FIG. 1) between the host vehicle 2 and the preceding vehicle 3.

The coordinate conversion unit 33 determines whether the curved road has the right-hand curve or the left-hand curve based on a sign (+ or −) of a signal indicating a horizontal position of the preceding vehicle 3 detected by the radar sensor 12.

For example, when the sign of the signal indicating the horizontal position of the preceding vehicle 3 detected by the radar sensor 12 is “+” (L_{X}>0), the coordinate conversion unit determines that the curved road has the right-hand curve. When the sign is “−” (L_{X}≤0), the coordinate conversion unit determines that the curved road has the left-hand curve.

As a result of calculation of Expression (1) above, when m>0, the coordinate conversion unit 33 determines that the preceding vehicle 3 is present on an outer side of the curve (A₁ and A₃). When m<0, the coordinate conversion unit 33 determines that the preceding vehicle 3 is present on an inner side of the curve (A₂ and A₄). When m=0, the coordinate conversion unit 33 determines that the preceding vehicle 3 is present on the estimated centerline E.

The coordinate conversion unit 33 converts a position of the preceding vehicle 3 that is present at the point A₁ at which L_{X}>0 and m>0 to a position of the point C₁ in the second coordinate system (L_{X}×m>0), for example. The coordinate conversion unit 33 converts a position of the preceding vehicle 3 that is present at the point A₂ at which L_{X}>0 and m<0 to a position of the point C₂ in the second coordinate system (L_{X}×m<0), for example.

The coordinate conversion unit 33 converts the position of the preceding vehicle 3 that is present at the point A₃ at which L_{X}<0 and m>0 to a position of the point C₁ in the second coordinate system (L_{X}×m>0), for example. The coordinate conversion unit 33 converts a position of the preceding vehicle 3 that is present at the point A₄ at which L_{X}<0 and m<0 to a position of the point C₂ in the second coordinate system (L_{X}×m<0), for example.

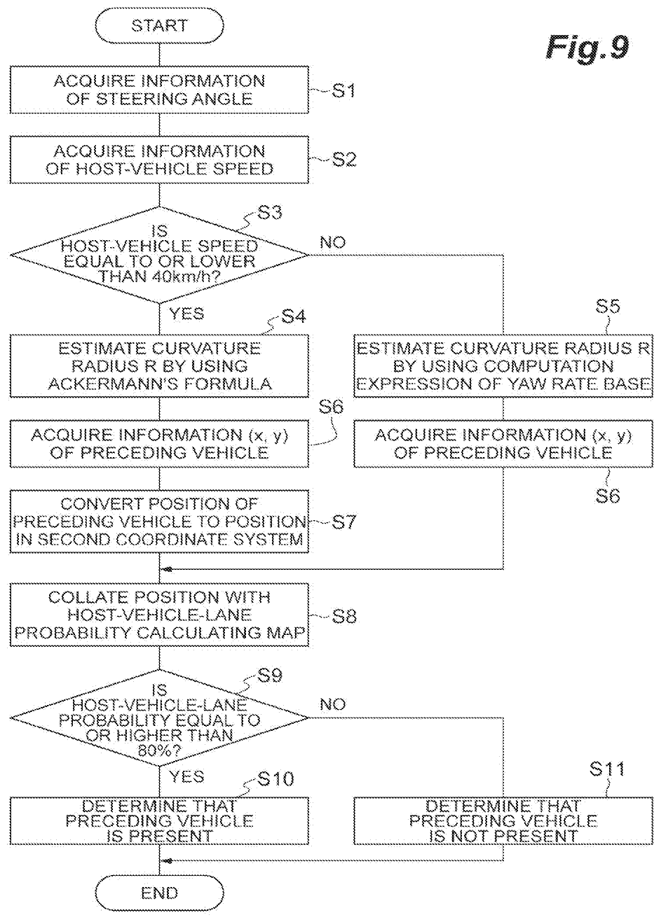

Next, a process procedure in the vehicle control system 1 will be described with reference to a flowchart in FIG. 9. First, the cruise ECU 25 acquires information of the steering angle of the host vehicle 2 output from the steering angle sensor 14 (Step S1).

Next, the cruise ECU 25 acquires information of the host-vehicle speed output from the vehicle speed sensor 11 (Step S2). Next, the vehicle speed determination unit 31 of the cruise ECU 25 determines whether or not the host-vehicle speed is equal to or lower than 40 km/h (Step S3). When the host-vehicle speed is equal to or lower than 40 km/h, the process proceeds to Step S4. When the host-vehicle speed is higher than 40 km/h, the process proceeds to Step S5.

In Step S4, the curvature-radius estimation unit 32 of the cruise ECU 25 estimates the curvature radius R by using Ackermann s formula. Specifically, the curvature-radius estimation unit 32 calculates the curvature radius R from the wheel base L_{WB} and the steering angle θ_{S} of the host vehicle 2 by using Expression (4).

The cruise ECU 25 executes Step S6 after Step S4. In Step S6, the cruise ECU 25 acquires information (x, y) related to the position of the preceding vehicle 3 output from the radar sensor 12.

Subsequently, in Step S7, the coordinate conversion unit 33 of the cruise ECU 25 converts the position of the preceding vehicle 3 to the position in the second coordinate system in which the straight line L_{PC} along the straight traveling direction Y is used as a reference. Specifically, the coordinate conversion unit 33 calculates the distance m by using Expression (1). The coordinate conversion unit 33 calculates the arc PQ by using Expression (11).

The coordinate conversion unit 33 calculates the second distance L_{X} (=x) based on positional information (x, y) of the preceding vehicle 3. As illustrated in FIG. 7, the coordinate conversion unit 33 converts the points A₁ and A₄ indicating the positions of the preceding vehicle 3 to the point C₁ and converts the points A₂ and A₃ indicating the positions of the preceding vehicle 3 to the point C₂. The cruise ECU 25 allows the process to proceed to Step S8 after Step S7.

On the other hand, when the host-vehicle speed is higher than 40 km/h in Step S3, the process proceeds to Step S5. In Step S5, the curvature-radius estimation unit 32 of the cruise ECU 25 calculates the curvature radius R of the curved road, on which the host vehicle 2 is traveling, by using a computation expression of a yaw rate base as in the related art. The cruise ECU 25 executes Step S6 after Step S5 and allows the process to proceed to Step S8.

In Step S8, the host-vehicle-lane probability calculation unit 34 of the cruise ECU 25 collates the positions C₁ and C₂ of the preceding vehicle 3 in the second coordinate system with the host-vehicle-lane probability calculating map M₁ (or M₂) (Step S8). From a result of collation, the host-vehicle-lane probability calculation unit 34 reads a corresponding numerical value on the host-vehicle-lane probability calculating map M₁ and sets the numerical value as the host-vehicle-lane probability of the preceding vehicle 3.

Subsequently, in Step S9, the host-vehicle-lane probability calculation unit 34 of the cruise ECU 25 determines whether or not the host-vehicle-lane probability is equal to or higher than 80%. When the host-vehicle-lane probability is equal to or higher than 80%, the cruise ECU 25 allows the process to proceed to Step S10 and determines that the preceding vehicle is present on the host-vehicle lane. When the host-vehicle-lane probability is lower than 80%, the cruise ECU 25 allows the process to proceed to Step S11 and determines that the preceding vehicle is not present on the host-vehicle lane. Here, the process is ended.

When the preceding vehicle 3 is present on the host-vehicle lane, the vehicle control ECU 24 of the vehicle control system 1 controls the inter-vehicular distance between the host vehicle 2 and the preceding vehicle 3 and performs control of maintaining the host-vehicle speed at the constant speed. For example, the vehicle control system 1 executes the constant speed traveling control and the inter-vehicular distance control in the entire vehicle speed range regardless of the host-vehicle speed.

The cruise ECU 25 of the vehicle control system 1 of the embodiment includes the vehicle speed determination unit 31 and estimates the curvature radius R of the road, on which the host vehicle 2 is traveling, based on the steering angle θ_{S}, when the host-vehicle speed is equal to or lower than the determination threshold value. Consequently, it is possible to estimate the curvature radius R without using the yaw rate. When the host-vehicle speed is equal to or lower than the determination threshold value, it is possible to estimate the curvature radius R of the road, on which the host vehicle is traveling, based on the steering angle θ_{S} while it is possible to limit an influence of an error. The coordinate conversion unit 33 of the cruise ECU 25 converts the position of the preceding vehicle 3 to the position in the second coordinate system. The position in the second coordinate system is obtained with the straight line L_{PC} along the straight traveling direction Y of the host vehicle 2 as a reference. Therefore, it is possible to significantly reduce a computation load more than in the case of converting the entire coordinate system as in the related art.

The radar sensor 12 of the vehicle control system 1 detects the first distance L_{Y} from the host vehicle to the preceding vehicle 3 in the straight traveling direction of the host vehicle 2 and the second distance L_{X} from the host vehicle 2 to the preceding vehicle 3 in the vehicle width direction X orthogonal to the straight traveling direction Y. The coordinate conversion unit 33 calculates the distance in between the preceding vehicle 3 and the tangential line L_{QT} of the curve (estimated centerline E) corresponding to the curvature radius R, the curve passing through the center of the host vehicle 2 in the vehicle width direction X. The host-vehicle-lane probability calculation unit 34 calculates the probability that the preceding vehicle 3 is present on the host-vehicle lane, based on the distance m. Consequently, in the vehicle control system 1, it is possible to calculate the probability that the preceding vehicle 3 is present on the host-vehicle lane and reduce the computation load, based on the second distance L_{X} from the host vehicle 2 to the preceding vehicle 3 in the vehicle width direction X.

The coordinate conversion unit 33 of the cruise ECU 25 calculates the distance m by using Expression (1) below. Therefore, in the coordinate conversion unit 33, it is possible to reduce the computation load more than in the case of converting the entire coordinate system as in the related art and calculate the probability that the preceding vehicle 3 is present on the host-vehicle lane.

[Math. 11]

m=[L_{Y}²+(|R|−|L_{X}|)²]^{0.5}−|R| (1)

The host vehicle 2 includes the engine retarder. The vehicle control ECU 24 can control the engine retarder to decelerate the host vehicle 2. Consequently, it is possible to appropriately maintain the inter-vehicular distance between the host vehicle 2 and the preceding vehicle 3. As a result, it is possible to reduce wear of the brake shoe during deceleration of the host vehicle 2.

The invention is not limited to the above-described embodiment, and it is possible to perform various modifications as follows, in a range without departing from the gist of the invention.

For example, in the above-described embodiment, a configuration, in which the radar sensor 12 is included, is described as a preceding-vehicle detection sensor that detects the position of the preceding vehicle 3 ahead of the host vehicle 2; however, the preceding-vehicle detection sensor is not limited to the radar sensor 12. For example, the positional information of the preceding vehicle may be acquired by using an in-vehicle camera (image sensor), inter-vehicle communication, or the like.

In the above-described embodiment, the low speed determination unit determines whether or not the host-vehicle speed is equal to or lower than 40 km/h (determination threshold value); however, the determination threshold value is not limited to 40 km/h and may be a different vehicle speed. For example, the determination threshold value may be a value that is lower than 40 km/h or higher than 40 km/h. For example, the determination threshold value can be set based on an experiment or data obtained in the past.

In the above-described embodiment, the probability that the preceding vehicle 3 is present on the host-vehicle lane is calculated by using the host-vehicle-lane probability calculating maps. However, the host-vehicle-lane probability may be calculated by a calculation process based on the position of the preceding vehicle 3, for example.

### REFERENCE SIGNS LIST

1: vehicle control system (preceding-vehicle determination apparatus), 2: host vehicle, 3: preceding vehicle, 5: host-vehicle lane, 11: vehicle speed sensor, 12: radar sensor (preceding-vehicle detection sensor), 14: steering angle sensor, 24: vehicle control ECU, 25: cruise ECU, 31: vehicle speed determination unit (low speed determination unit), 32: curvature-radius estimation unit, 33: coordinate conversion unit, 34: host-vehicle-lane probability calculation unit (preceding-vehicle presence/absence determination unit), L_{QT}: tangential line, L_{X}: second distance, L_{Y}: first distance, X: vehicle width direction, Y: straight traveling direction.

1. A preceding-vehicle determination apparatus comprising:
a vehicle speed sensor that detects a speed of a host vehicle;
a preceding-vehicle detection sensor that detects a position of a preceding vehicle ahead of the host vehicle;
a steering angle sensor that detects a steering angle of the host vehicle;
a low speed determination unit that determines whether or not the vehicle speed of the host vehicle detected by the vehicle speed sensor is equal to or lower than a determination threshold value;
a curvature-radius estimation unit that estimates a curvature radius R of a road, on which the host vehicle is traveling, based on the steering angle, when the vehicle speed is equal to or lower than the determination threshold value;
a coordinate conversion unit that converts, based on the curvature radius R, the position of the preceding vehicle in a first coordinate system in which a curve corresponding to the curvature radius R is used as a reference to a position in a second coordinate system in which a straight line along a straight traveling direction of the host vehicle is used as a reference; and
a host-vehicle-lane probability calculation unit that calculates a probability that the preceding vehicle is present in a host-vehicle lane, based on the position of the preceding vehicle in the second coordinate system.

2. The preceding-vehicle determination apparatus according to claim 1,
wherein the preceding-vehicle detection sensor detects a first distance L_{Y} from the host vehicle to the preceding vehicle in the straight traveling direction of the host vehicle and a second distance L_{X} from the host vehicle to the preceding vehicle in a vehicle width direction orthogonal to the straight traveling direction,
wherein the coordinate conversion unit calculates a distance m between the preceding vehicle and the curve corresponding to the curvature radius R, the curve passing through a center of the host vehicle in the vehicle width direction, and
wherein the host-vehicle-lane probability calculation unit calculates a probability that the preceding vehicle is present on the host-vehicle lane, based on the distance m.

3. The preceding-vehicle determination apparatus according to claim 2,
wherein the coordinate conversion unit calculates the distance m by using Expression (1) below.
m=[L_{Y}²+(|R|−|L_{X}|)²]^{0.5}−|R| (1)

4. A vehicle control system comprising:
the preceding-vehicle determination apparatus according to claim 1;
a preceding-vehicle presence/absence determination unit that determines whether or not the preceding vehicle is present on the host-vehicle lane, depending on a probability that the preceding vehicle is present on the host-vehicle lane; and
a vehicle control unit that controls an inter-vehicular distance between the preceding vehicle and the host vehicle, when the preceding vehicle is present on the host-vehicle lane.

5. The vehicle control system according to claim 4,
wherein the host vehicle includes an engine retarder, and
wherein the vehicle control unit controls the engine retarder to decelerate the host vehicle and control the inter-vehicular distance.
